(19) United States
(12) Patent Application Publication
(10) Pub. No.: US 2021/0250305 A1
(43) Pub. Date: Aug. 12, 2021

(54) SYSTEM AND METHOD TO MANAGE AND EXCHANGE RESOURCES BETWEEN ENTERPRISES IN A CLOUD COMPUTING ENVIRONMENT

(71) Applicant: Camila do Espirito Santo, San Jose, CA (US)

(72) Inventor: Camila do Espirito Santo, San Jose, CA (US)

(21) Appl. No.: 17/168,471

(22) Filed: Feb. 5, 2021

Related U.S. Application Data
(60) Provisional application No. 62/971,079, filed on Feb. 6, 2020.

(51) Int. Cl. H04L 12/923; H04L 12/911; H04L 12/927; H04L 12/26

(52) U.S. Cl. CPC H04L 47/762; H04L 47/781; H04L 43/0817; H04L 47/822; H04L 47/80

(57) ABSTRACT

A system to manage and exchange resources between enterprises in a cloud computing environment is disclosed. The system includes an information classifying subsystem, configured to classify one or more collected enterprise data into one or more resource groups based on the type and content of the enterprise data using an artificial intelligence-based segmentation model. The system includes a dynamic distribution subsystem, configured to dynamically distribute the classified one or more resource groups with each other based on one or more predefined parameters using an artificial intelligence-based data recommendation technique. The system includes a performance data generator subsystem, configured to generate performance data associated with the enterprise based on the dynamically distributed one or more resource groups. The system includes a resource operation management subsystem, configured to perform operations on the one or more resources based on type of the one or more resources and one or more user privileges.

### EARLIEST PRIORITY DATE

This application claims priority from a Provisional patent application filed in the U.S. Patent Application No. 62/971,079, filed on Feb. 6, 2020, and titled “COOPERATIVE METHOD AND SYSTEM FOR B2B NETWORKING”.

### FIELD OF INVENTION

Embodiments of a present disclosure relates to a business-to-business (B2B) networking system dedicated for enterprise cooperation, independently of the enterprises economic sector, and more particularly to a system and a method to manage and exchange resources between enterprises in a cloud computing environment.

### BACKGROUND

Business networking refers to joint efforts by a group of organizations working together to accomplish complementary market objectives. Business networks do not require these cooperating parties to share the same industry, nor the same risks and returns over their shared interests, opportunities, and projects. A business network processes business-to-business relations. Business-to-business involve commercial transactions between enterprises, including from the public and non-profit sectors, either local or cross-border.

Business-to-business networking may also incorporate members of different production chains, industries, sectors and territories, such as developers, suppliers, distributors, or clients. Such organizations may communicate through individual representatives from different enterprise departments.

It is important to note that business-to-business concept along with stated business network is growingly predominant worldwide, generating more trade than business-to-consumer (B2C) exchanges on a macroeconomic level. But the idea is still an immature concept as it is not associated with scientific models applied by prior art. There is a lack of structural domain knowledge in business-to-business networking technologies despite its increasing commercial application. Such lack of advancement in times of increasing need explains how important it is to create proper online negotiation and online collaboration systems between enterprises as it is a way for enterprises to recognize, create, or act upon business opportunities, by generating and exchanging information and resources for the benefit of the macroeconomy.

Hence, there is a need for an improved system to manage and exchange resources between enterprises in a cloud computing environment and a method to operate the same and therefore address the aforementioned issues.

### BRIEF DESCRIPTION

In accordance with one embodiment of the disclosure, a system to manage and exchange resources of enterprises in a cloud computing environment. The system includes a hardware processor for data accessibility and distribution of information. The system also includes a memory coupled to the processor. The memory comprises a set of program instructions in the form of a plurality of subsystems and configured to be executed by the processor. The system also includes an information collection subsystem. The information collection subsystem is configured to collect one or more enterprise data from each of the enterprises in a pre-defined format. The system also includes an information classifying subsystem. The information classifying subsystem is configured to classify one or more collected enterprise data into one or more resource groups based on the type and content of the enterprise data using an artificial intelligence-based segmentation model.

The system also includes a dynamic distribution subsystem. The dynamic distribution subsystem is configured to dynamically distributes the classified one or more resource groups with each other based on one or more predefined parameters using an artificial intelligence-based data recommendation technique. The system also includes a performance data generator subsystem. The performance data generator subsystem is configured to generate one or more performance data associated with the enterprise based on the dynamically distributed one or more resource groups. The system also includes a resource operation management subsystem. The resource operation management subsystem is configured to perform one or more operations on the one or more resources based on type of the one or more resources and one or more user privileges.

In accordance with one embodiment of the disclosure, a method for managing resources of enterprises in a cloud computing environment is disclosed. The method includes collecting one or more enterprise data from each of the enterprises in a pre-defined format. The method also includes one or more collected enterprise data into one or more resource groups based on the type and content of the enterprise data using an artificial intelligence-based segmentation model. The method also includes distributing dynamically the classified one or more resource groups with each other based on one or more predefined parameters using an artificial intelligence-based data recommendation technique.

The method also includes generating one or more performance data associated with the enterprise based on the dynamically distributed one or more resource groups. The method also includes performing one or more operations on the one or more resources based on type of the one or more resources and one or more user privileges.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram illustrating an exemplary computing system to manage and exchange resources between enterprises in a cloud computing environment in accordance with an embodiment of the present disclosure;

FIG. 2 is a block diagram illustrating another exemplary computing system environment to manage and exchange resources between enterprises in accordance with an embodiment of the present disclosure;

FIG. 3a is a schematic representation of another exemplary computing environment detailing the information collection subsystem in accordance with an embodiment of the present disclosure;

FIG. 3b is an architectural view of the computing system capable of managing resources of enterprise in accordance with an embodiment of the present disclosure;

FIG. 4a is a screenshot view of an exemplary graphical user interface capable of managing resources of an enterprise in accordance with an embodiment of the present disclosure;

FIG. 4b is a screenshot view of an exemplary graphical user interface capable of managing resources of an enterprise in accordance with another embodiment of the present disclosure;

FIG. 4c is a screenshot view of an exemplary graphical user interface capable of managing review of resources of an accordance with yet another embodiment of the present disclosure;

FIG. 4d illustrates project dashboard definition, operation and communication of business-to-business process;

FIG. 5 is a block diagram illustrating a various component in the computing system, such as those shown in FIG. 1, in accordance with an embodiment of the present disclosure; and

FIG. 6 is a process flowchart illustrating an exemplary method for managing and exchanging resources between enterprises in a cloud computing environment in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, subsystems, elements, structures, components, additional devices, additional subsystems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

A computer system (standalone, client or server computer system) configured by an application may constitute a “subsystem” that is configured and operated to perform certain operations. In one embodiment, the “subsystem” may be implemented mechanically or electronically, so a subsystem may comprise dedicated circuitry or logic that is permanently configured (within a special-purpose processor) to perform certain operations. In another embodiment, a “subsystem” may also comprise programmable logic or circuitry (as encompassed within a general-purpose processor or other programmable processor) that is temporarily configured by software to perform certain operations.

Accordingly, the term “subsystem” should be understood to encompass a tangible entity, be that an entity that is physically constructed permanently configured (hardwired) or temporarily configured (programmed) to operate in a certain manner and/or to perform certain operations described herein.

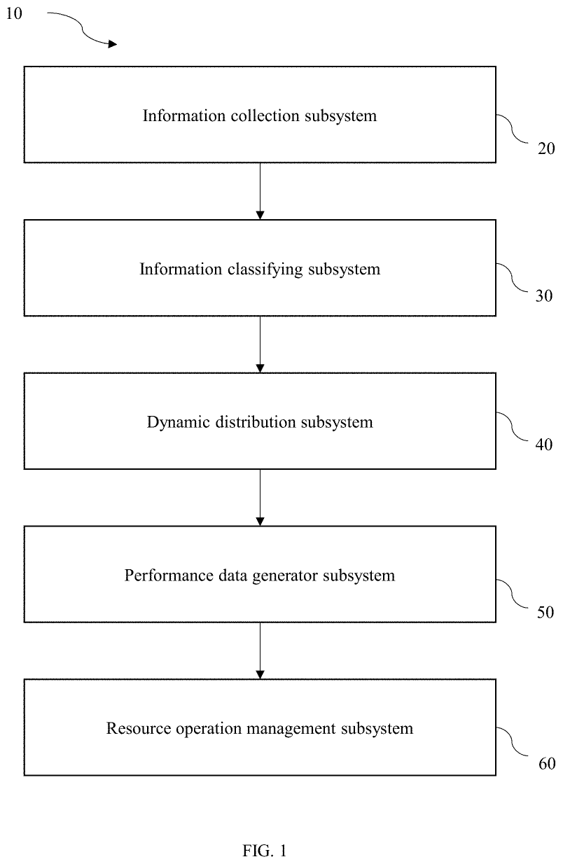

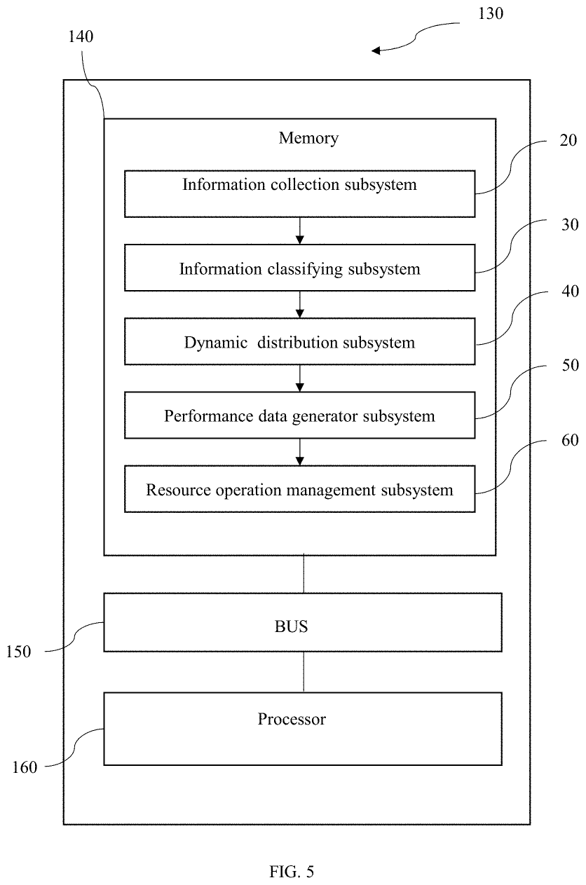

FIG. 1 is a block diagram illustrating an exemplary computing system 10 to manage and exchange resources by and between enterprises in a cloud computing environment in accordance with an embodiment of the present disclosure. These resources are collected in the form of machine-readable raw data and classified for generation and distribution in groups of human-readable information traditionally present in digital documents and or assets, such as datasets and logs, projects, contracts and electronic payments. Examples of machine readable raw data comprise numeric (quantifiable) or composite (derivable) sets of bits that represent distinctions, possibilities, combinations, predefinitions, affiliations, variations and memorization of values of qualitative or quantitative variables defining space or behaviour of one or more units such as integers, floating-point numbers, characters, strings, Booleans; mathematical constructs that can be operated by programming languages as statistical variables such as intervals, ratio, random, binary, and categorical; objects, especially text, that can be modelled as syntactic labels explaining semantic meanings; abstract implementations of data types such as time-series, rankings, deviations, part-to-whole, frequency distributions, nominal comparisons, correlations, and geospatial; directives such as pointers and references, functions, utility (time, date and currency), and meta decisions (regarding higher computational introspection and reflection). Examples of human readable information include categorical representations of variables with a particular characteristic, nominal (no order between them) or ordinal (ordered); and quantitative representations of measurements either continuous (ideas that can change over time) or discrete (finite number of possibilities). The system 10 classifies and generates such data and information for the purpose of incentivizing a social networking structure dedicated for enterprise cooperation through easier distribution of these different resource groups in the format of traditional types of display through data visualization such as lists, boxes, tables, charts and graphs. length/count, category, colour, bin limits, x/y positions, symbol/glyph, size, nodes, ties, width, timeline, radial distance (dependent variable), rotating angle (cycling), flows, attributes, and graphical relations between shapes for the purpose of facilitating the user's perception of correlations between the data by objectifying ideas, connections, interactions, volume and flows of exchange, jointure, time passing. The system 10 comprises a set of program instructions in the form of a plurality of subsystems that supports such enterprises on managing with independent autonomy each owned enterprise resource groups to achieve reaching consensus concerning the exchange of such resources. The detailed view of other components of the system 10 are further described in FIG. 5.

It is pertinent to note that the system 10 may be externally hosted on a hybrid cloud server architecture (which allows users to share responsibility over data security for greater control over sensitive information). In such embodiment, the users indicated here refers to one or more enterprise organizations. This architecture layouts a connection between multiple cloud hosting servers, sometimes public (when users connect to each other and exchange data via a same server with no need to commit on data privacy), sometimes private (when users agree upon sharing confidentiality protected by a more secured server). In this system 10, the determination of public and private cloud hosting is determined by the enterprise data sources. Enterprise data sources that are open and public are hosted on a public cloud and those that are proprietary are hosted on private cloud.

The plurality of subsystems comprises a registration module configured to register each of the enterprises with a first set of details, organizational and individual. The first set of details comprises information about enterprise legal identification, enterprise location, enterprise domain of production, the enterprise classification in relational and transactional processes in the system. The second set of details comprises information about each enterprise's individual representative including each individual identification, professional position within the enterprise, department in the enterprise, and authority such individuals receive to operate the system processes with administrative roles. The enterprise individual representatives have user privileges depending on their system authority roles. The system 10 via the registration determines also which data will be visible to which person. In such embodiment, a registered enterprise may access some data while another registered may not access that specific data, depending if such data source is hosted on a public cloud server or private data server. Here, the data refers to one or more enterprise data.

This feature provides then user control over enterprise information confidentiality and individual data privacy data during operation of the system 10 through an adaptive cybersecurity using data quality protocols to prevent cyberattacks, spammers, page hijacking based on application diagnostics. Proprietary information is encoded to be visualized only by registered users and which will determine what content visual displays non-registered users can see. This affects system content modulation and encapsulation making information to be differently accessible to different users. The type of content that can be visualized by any user must be legally available for distribution on a public license basis or open-source licensing model. The type of content that will be available only to registered users is information that represents digital property and which rights for distribution have been limited by the rights owners to be displayed in this system.

The plurality of subsystems comprises an information collection subsystem 20. The information collection subsystem 20 is configured to collect one or more enterprise data from each of the enterprises in a pre-defined format. The enterprise data comprises numeric data, and textual data referring to financial and legal information.

The one or more enterprise data comprises enterprise reputation data, and enterprise historical data such as the enterprise current status and interest for offer or demand of services.

The system 10 includes an information classifying subsystem 30. The information classifying subsystem 30 is configured to classify one or more collected enterprise data into one or more resource groups based on an artificial intelligence-based segmentation model Classes of data may include structured data (company industry, size and geolocation, company and employee names, employee position and department, event and transaction dates, card numbers, inventory and stock listings), and unstructured data (natural language processing and understanding, semantic analysis, metadata tagging, processing frameworks). Each of the one or more resource groups comprises one or more resources corresponding to the one or more collected enterprise data. The one or more resources groups comprises projects group associated with the enterprises, account group associated with the enterprise, template group associated with the enterprise and library group.

In such specific embodiment, the artificial intelligence-based segmentation model classifies the enterprise data that was stored, retrieved, and transmitted by either individuals or empirical machine distinguishing data events from informational objects. The artificial intelligence-based segmentation model represents a knowledge graph model that segments resource groups in scenarios of social networking vulnerability, viability, acceptability and profitability to recommend the best matchmaking of an offer-demand fit, sometimes recommending industry best practices, sometimes focused on affinity propagation for trust acceleration. The graph is structured on a quadrant that displays prospective cooperating parties according to the enterprise project features via a calculator interface that can be set via a conditional form. In another such embodiment, the segmentation model operates algorithmic processes that service to extract knowledge from computing machines (computer, mobile phone, and any other device that can access the Internet) to qualify these structures in scalable protocols, ontologies, taxonomies, frameworks, licenses, models, and libraries that may operate like simulated human cognitive processes such as comprehension, analysis, learning, communication, cooperation, problem-solving. The artificial intelligence-based segmentation model automates this way data observability (monitoring, tracing and log management) for better orchestration and security (device data checking) of re-usable application functionalities without the complexity of building and maintaining a network or cloud infrastructure. This way, the system may treat entering data (whether batch processing, stream processing, extract-transform-load processing, internet-connected or web applications) more securely (most cyberattacks occur when the access to server is not hidden from the users) and economically (on-demand functionality incurring in charges only when used) than prior art.

The system 10 also includes a dynamic distribution subsystem 40. The dynamic distribution subsystem 40 is configured to dynamically distribute the classified one or more resource groups with each other based on one or more predefined parameters using an artificial intelligence-based data recommendation technique. The one or more predefined parameters comprises experience level parameters, exclusivity parameters, availability, time zone difference, budget, social impact, languages, contract agreement type, and delivery time. This subsystem 40 comprises a search engine operating these parameters as matchmaking filters used as negotiation metrics that process objective data (that is composed by history of trade data, whether relational or transactional, from the system data sources or external data sources) to segment data by classes of identify and then predict trading behaviours.

The search results activate a workflow repository that predict and recommend trade orders, and transactions automatically, while respecting authority control protocols to process legal-related textual data and financially relevant numeric data according to negotiation semantic terms between registered users. It is able to incorporate external data to track, monitor, and audit business processes, applicable laws, organizational policies, and industry standards that parties may need to comply with because it acts as a hypervisor of interactions between users, tracking conversational and conditional dialogues logs with interoperability. Users select recommendations or input their own controlling triggering notifications, storing trade records, activities, arrangements, while protecting copyright. Therefore, it is an important component of the system memory.

The dynamic distribution of the classified one or more resource groups with each other comprises generation of a score based on the one or more predefined parameters, assign a rank on the generated score and distribute the one or more resource groups with each other based on the rank assigned to generated scores. The best rank suited is dynamically distributed for further operations involving the search engine in the Subsystem 40.

Few procedures are being used for the distribution such as searching about similar domain enterprises via a search engine, collecting data from a social network database and viewing the data from a portfolio gallery. Both textual and visual, filtered by term searched, which must be a word that describes a service and the requester trade interest (provide or procure service). User generated content is entered by registered users that fill out informational forms structured with matchmaking filters that are converted into matchmaking features for data visualization. Such matchmaking process is important as it distributes the similar trade service. Data entered by users is verified before being authorized in their authenticity, veracity, and compliance with the present method via object-relational events that track navigational data.

The system 10 also includes a performance data generator subsystem 50. The performance data generator subsystem 50 is configured to generate one or more performance data associated with the enterprise based on the dynamically distributed one or more resource groups. Here, the one or more performance data is representative of entity negotiated tax details, entity negotiated compliance details, entity negotiated invoice details, entity negotiated payroll details and entity negotiated remedies. Simultaneously, the system 10 via a validation subsystem configured to validate the performance data associated with the enterprise data using one or more pre stored validation rules. The system 10 via a visualization subsystem visualizes the performance data in one or more graphical representation form on a user interface of a user device.

The system 10 also includes a resource operation management subsystem 60. The resource operation management subsystem 60 is configured to perform one or more operations on the one or more resources based on type of the one or more resources and one or more user privileges. The one or more operations comprises providing an interactive artificial intelligence assisted chatting interface to the one or more users, providing the legal arbitration component for the one or more users, producing digital accounting documentation for the one or more users, managing digital assets of the enterprise and providing compensation to the users via electronic payment. For such performance, the system 10 first via enterprise data collaboration subsystem analyses performance data associated with one enterprise data with respect to performance data associated with another enterprise data using artificial intelligence-based enterprise data model.

The artificial intelligence-based enterprise data model comprises a chatting interface transforms negotiation dialogues between enterprises individual users into metadata by using a hypervisor application that identifies semantic units and stores them as usable data units for legal transactions. These semantic units are stored on legal content repositories accessible via RSS and XML feeds. The legal arbitration repositories can be mutually managed by the users via a multi signature tool for consensus validation optionally via proof of authority and fault toleration, but also more simply via a fraud detection framework, supported by a delegation protocol (that checks data veracity from external data authentication repositories). Digital accounting documentation in result of the electronic payments scheduled to be operated by this system, include invoicing, orders and receipts that can be uploaded and downloaded by the users. These transactional records concerning liabilities and warranties, compliance and remedies are supported by a calculator of indemnification and remedies in the advent of a claim between one or more parties.

Electronic payments depend on identity authentication that has a data integrity verification by authorized certification authority that provides confidentiality to the electronic information exchanged in the system in conformity with this system's security layer to safeguard any portion of the transaction conducted over public networks because of the access to the internet operated by the user, this system, or the certification authority. The enterprise performance data can be affected by these factual records classifying reputation data concerning tangible and intangible assets creation, contribution, and transformation. structures the negotiation and consensus processes on a collaboration workflow engine enabling the memory of such data units for recommended mutual decision-making during the iterative assessment of timelines, agenda, and delivery, or for risk and change management with features for logging, reporting, authoring, approving, investigating and resolving compliance matters. In the end of this process, enterprises reputation data is stored on a reward catalogue that uses machine learning for personalized, organizational and relational evaluations are stored on an eligibility calculator that generates unique code generators (tokenization embedding sequencing) that can be tracked and control triggers of affinity propagation. And then, enterprise data collaboration subsystem recommends one or more operations on the one or more resources of the one enterprise data based on the analysis.

In one embodiment, the system 10 facilitates digital accounting documentation in result of the electronic payments, including invoicing, orders and receipts that can be uploaded by the users. The process tracks records of operations by users that occur outside the system 10 such as expenses and time that the users must entry in correspondence to the agreements made via the system 10. In another embodiment, the system 10 facilitates online compensation like acceptance of electronic payment for online transactions.

In yet another embodiment, the system 10 provides access to human and/or machine conversation tool that enables negotiating potential cooperation on a project. For working, this tool transforms dialogue into metadata by using a hypervisor application that identifies semantic units and stores them as usable data units. In one embodiment, the system 10 provides legal content repositories based on in automated research and that automates agreement documentation with terms contained in the communications exchanged between the parties. The process offers a multi signature tool based on data mining, consensus, and propagation protocols that allows a validation of informational proof of authority and fault toleration, but also a fraud detection framework, supported by a delegation protocol (that checks data veracity) and machine learning for documents regularization. Furthermore, the system 10 manages definitional, factual, policy, and value allegations that may have been disputed throughout the user's interactions presenting an interface.

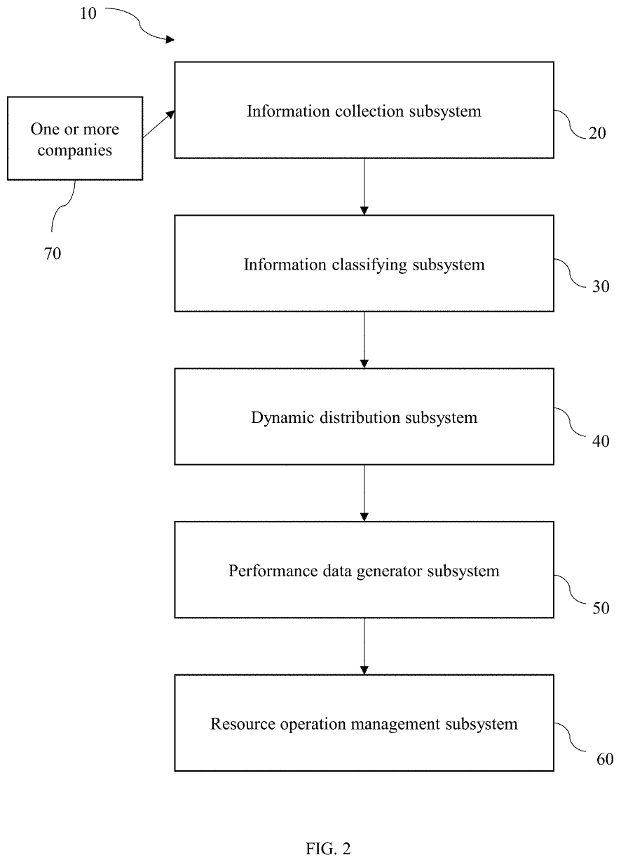

FIG. 2 is a block diagram illustrating another exemplary computing system 10 environment to manage resources of enterprise in accordance with an embodiment of the present disclosure. One or more companies 70 seek to use the stated computing system 10 to obtain matchmaking with organizations. The system 10 via an information collection subsystem 20 obtains information or raw data of enterprise in a pre-defined format.

Further, by an information classifying subsystem 30, the system 10 is configured to classify one or more collected enterprise data into one or more resource groups based on the type and content of the enterprise data using an artificial intelligence-based segmentation model. For example, one or more companies 70 create project requests and proposals using more specific classifications that are based on machine learning recommendations that constantly analyse the data collected by the system.

After such classification, the system 10 dynamically distributes the classified one or more resource groups with each other based on one or more predefined parameters using an artificial intelligence-based data recommendation technique. The one or more predefined parameters comprises at least one of parameter representative of experience level, exclusivity, availability, time zone difference, budget, social impact, languages, contract agreement type, and delivery time.

Here, for distributing dynamically, the system 10 in a dynamic distribution subsystem 40 first generates a score based on the parameters and then assigns a score for the basis of distribution. The system 10 allows the analysis and visualization of a panorama of real-time services offers and demands in an order that is beneficial for the party-to-party matchmaking.

Further, a performance data generator subsystem 50 generates one or more performance data associated with the enterprise based on the dynamically distributed one or more resource groups. Such stated performance data enables the trade negotiation. The transformation of the status of enterprise into the status of trader occurs when a proposal from a provider is accepted by a procurer. The performance data generator subsystem 50 helps in such changes. Furthermore, the system 10 uses the same intelligence for matchmaking for users to calculate comparisons between prospective business to business matches by forming a quadrant benchmark analysis with the same metrics that distribute data across the process of users/traders interactions.

Lastly, the system 10 via a resource operation management subsystem 60 performs one or more operations on the one or more resources based on type of the one or more resources and one or more user privileges. Here, the enterprise owner has access to content like tax, compliance, invoices, payroll and remedies. A pre-defined privilege may be set for any specific user enterprise.

The information collection subsystem 20, the information classifying subsystem 30, the dynamic distribution subsystem 40, the performance data generator 50, the resource operation management subsystem 60 in FIG. 2 is substantially equivalent to the information collection subsystem 20, the information classifying subsystem 30, the dynamic distribution subsystem 40, the performance data generator 50, the resource operation management subsystem 60 of FIG. 1.

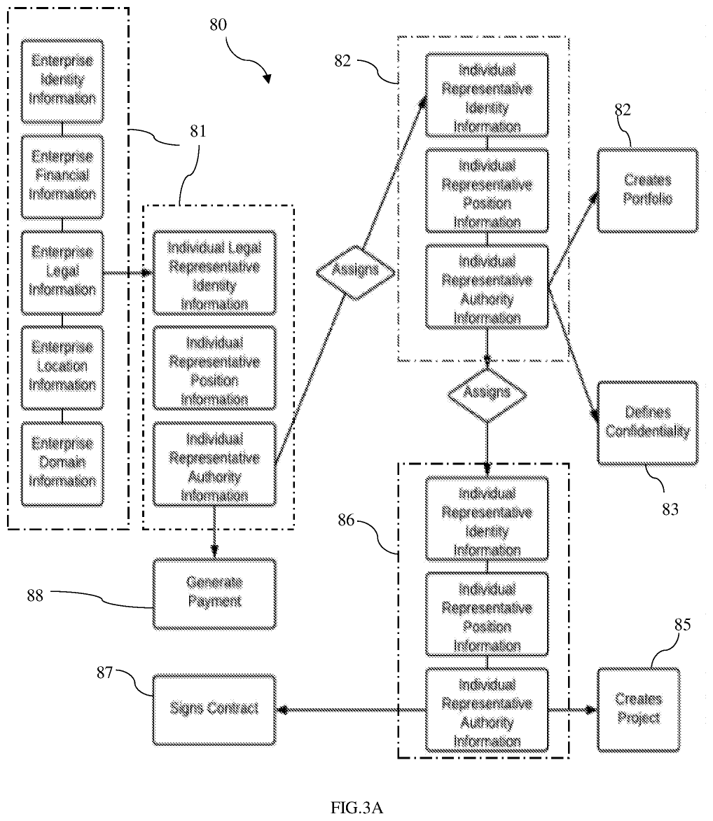

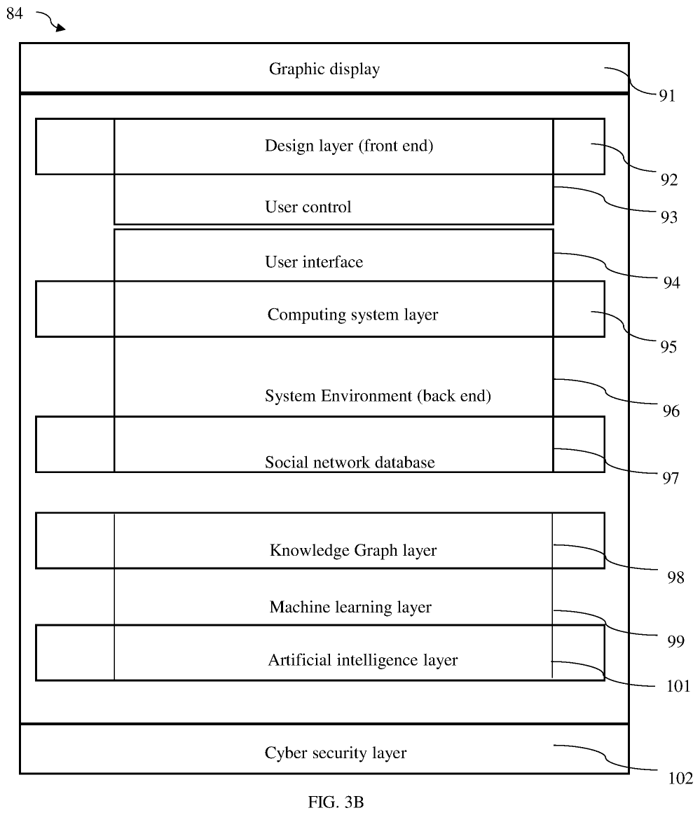

FIG. 3a is a schematic representation of another exemplary computing environment 80 detailing the information collection subsystem 20 in accordance with an embodiment of the present disclosure. The illustration basically shows the pathway of the input data through the whole concerned system. First the system 10 collects individual details and organizational details 81 via the information collection subsystem 20. The details may be enterprise identity information, enterprise financial information, enterprise legal information, enterprise location information, enterprise domain information, individual legal representative identity information, individual representative position information, individual representative authority information. Payment 88 contribution is also generated for the same. The system 10 creates portfolio 82 and defines confidentiality 83 of individual representative position information, individual representative authority information 82, 86. Based on the portfolio and other factors, the system 10 creates project 85 and assigns contract 87.

FIG. 3b is an architectural view of the computing system 84 capable of managing resources of enterprise in accordance with an embodiment of the present disclosure. The back end and front end of the hosted system operate by layers that only divide graphic display from cybersecurity 10. The back end 96 and front end 92 of the hosted system 10 operate by layers that only divide graphic display 91 from cybersecurity 102. Between the design layer 92 and computing system layer 95, user control 93 and user interface 94 layers are located. Social network layer 97 is coupled to the back end layer 96. Machine learning layer 99 is located between knowledge graph layer 98 and artificial intelligence layer 101.

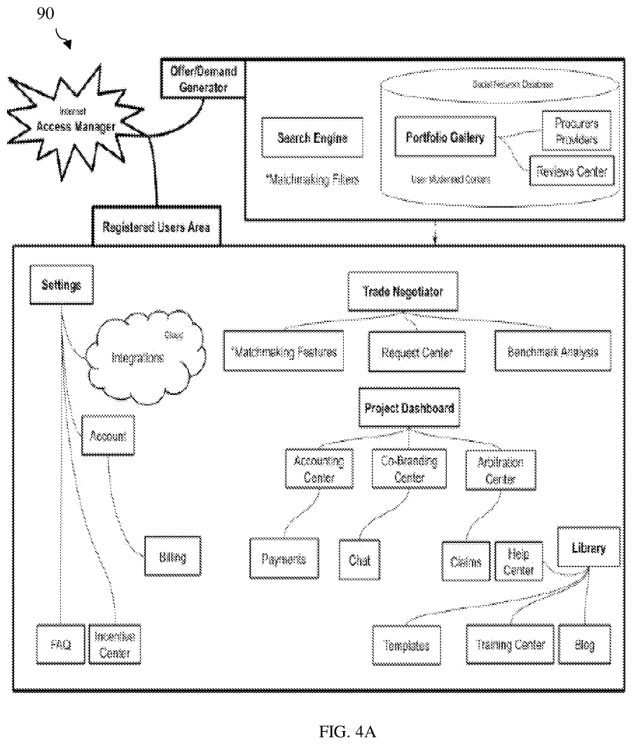

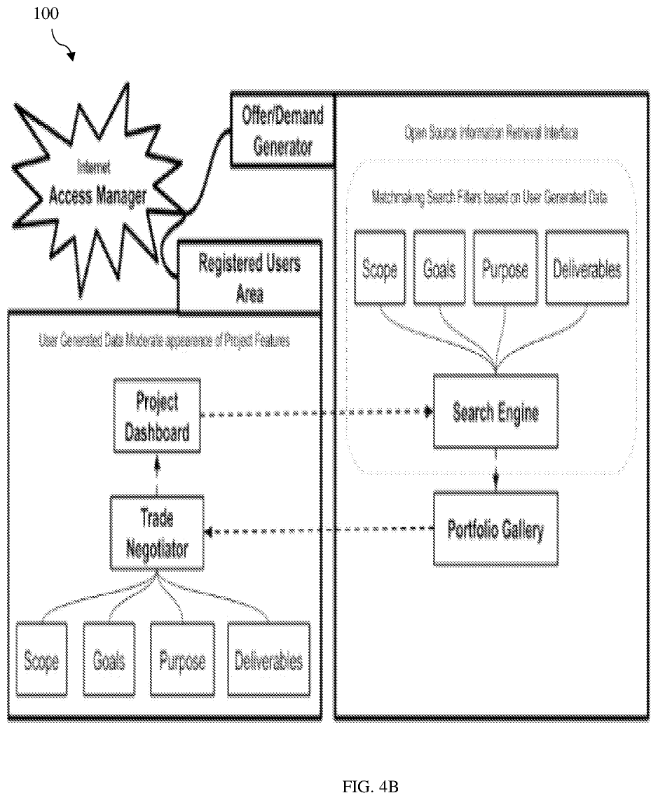

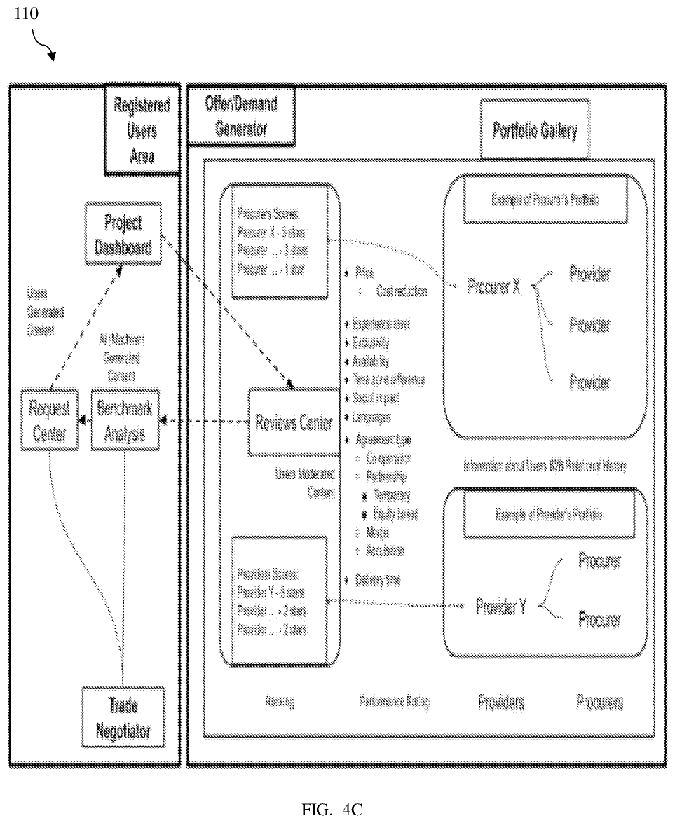

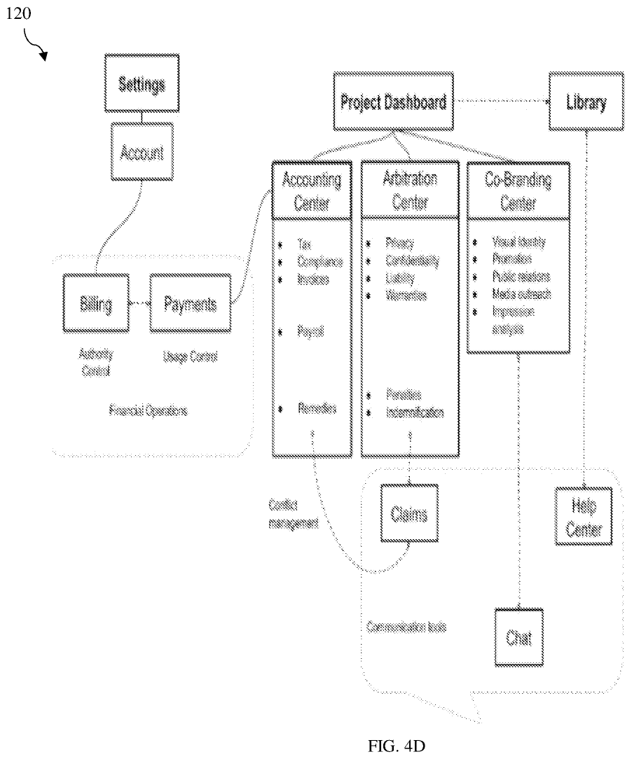

FIG. 4a is a screenshot view of an exemplary graphical user interface 90 capable of managing resources of enterprise in accordance with an embodiment of the present disclosure. The invention is processed on a platform accessible on the internet. This platform partially cloud-hosted in a suite of modules or subsystems of integrated applications that collect, store, manage and interpret data in real-time. Registered users' area in the figure may be inferred as information collection subsystem. Search engine in the figure may be inferred as Information Classifying subsystem 30. Trade negotiator may be inferred as Dynamic Distribution Subsystem 40.

Performance Data Generator Subsystem 50 in this figure is substituted by Offer Demand Generator. Resource Operation Management Subsystem 60 is substituted in the figure by Project Dashboard. And lastly, one or more companies 70 is substituted by Access Manager.

FIG. 4b is a screenshot view of an exemplary graphical user interface 100 capable of managing resources of enterprise in accordance with another embodiment of the present disclosure. Through the access manager, the user accesses an opensource search engine in the offer/demand generator that features the same filters from the registered user area. The information provided then respects the registered user's confidentiality, protecting sensitive information from the project dashboard and trade negotiator. Hence, before the matchmaking, users remain anonymous to each other, in a way of preventing decision-making biases and misuse of the platform. Once both parties agree that they should work together, the portfolio pages of both parties become mutually accessible with increasing revelation of information throughout the negotiation process.

It is pertinent to note that performance data generator subsystem 50 is substituted as offer demand generator and public cloud server in the figure. Information Collection Subsystem 20 is substituted with registered users' area and contains private cloud server in the figure. Here, the processor 160 is substituted by internet access manager. Similarly, as stated in FIG. 4 a, information classifying subsystem 30 is substituted by search engine, dynamic distribution subsystem 40 is substituted by trade negotiator and resource operation management subsystem 60 is substituted by project dashboard.

FIG. 4c is a screenshot view of an exemplary graphical user interface 110 capable of managing review of resources of an accordance with yet another embodiment of the present disclosure. Then, once registered users get more information about the profile of projects identified by the analysis, they can also examine party's business to business history and reviews. After selecting parties from the reviews centre, the user can compare them on a benchmark analysis, leading to the request centre that prepares the users to connect for the first time in the matchmaking. Finally, when prospects are identified, the negotiation process is done directly over the project dashboard (where operations occurs).

It is pertinent to note that this figure, performance data generator subsystem 50 is substituted by offer demand generator. Information collection subsystem 20 is substituted by registered users' area. Reputation ranking is substituted by reviews centre. One or more companies 70 is substituted procurers/providers. Resource operation management subsystem 60 is substituted by project dashboard. Dynamic distribution subsystem 40 is substituted by trade negotiator.

FIG. 4d illustrates project dashboard definition, operation and communication 120 of business-to-business process. The notifications feature present in the dashboard are set to stimulate attention accordingly to the interactive goals of each user and perform as both parties process their productive tasks in real life. Communication is processed by the users in the same project dashboard, making it a shared entity. Authority and usage control determine how users can insert, read and edit information. Here, the resource Operation Management Subsystem 60 is substituted by project dashboard.

The system (10) proposes a project dashboard consisting of an artificially intelligent component of the platform that inserts principles of production engineering in project management. Such principles are converted into data analysis and data visualization computing operations that are translated in e-Learning sections of the platform such as the templates feature, and training and incentive centres.

These principles are also presented quantitatively and qualitatively through Bots and machine learning components offering: Mathematical calculations of available resources and time in each step of the cooperation in comparison with possible optimizations of their use accordingly to the productive goals set by the users; Statistical calculations of platform usability accordingly to users' operational input in order to update and ameliorate the suggestions made by the system taking into consideration the constraints and particularities of the related communities of users; Semantic analysis of work offers and demands, as well as environmental impact of production chains, in order to predict and stimulate the generation of future work opportunities; Incorporation of concepts and quality standards massively input by users, following their specific industry and placement in production chains; Technological update of accessibility and interoperability with the computing codes of social media channels that are integrated to platform allowing distribution of external data into the users workflow optimization to accelerate and scale productions.

FIG. 5 is a block diagram illustrating a various component in the computing system, such as those shown in FIG. 1, in accordance with an embodiment of the present disclosure.

The processor(s) (160), as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory (140) includes a plurality of subsystems stored in the form of executable program which instructs the processor (160) via bus (150) to perform the method steps illustrated in FIG. 1. The memory (140) has following subsystems: the information collection subsystem 20, the information classifying subsystem 30, the dynamic distribution subsystem 40, the performance data generator 50, the resource operation management subsystem 60.

The information collection subsystem 20 is configured to collect one or more enterprise data from each of the enterprises in a pre-defined format. The information classifying subsystem 30 is configured to classify one or more collected enterprise data into one or more resource groups based on the type and content of the enterprise data using an artificial intelligence-based segmentation model. The dynamic distribution subsystem 40 is configured to dynamically distribute the classified one or more resource groups with each other based on one or more predefined parameters using an artificial intelligence-based data recommendation technique.

The performance data generator subsystem 50 is configured to generate one or more performance data associated with the enterprise based on the dynamically distributed one or more resource groups. The resource operation management subsystem 60 is configured to perform one or more operations on the one or more resources based on type of the one or more resources and one or more user privileges.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or hardware data interoperability contexts. Executable program stored on any of the above-mentioned storage media may be executable by the processor(s) (160).

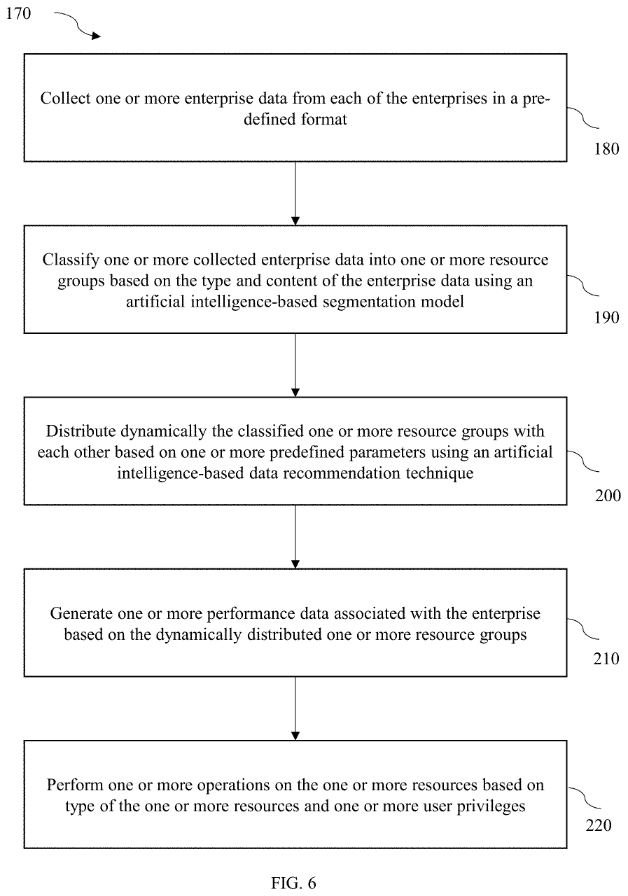

FIG. 6 is a process flowchart illustrating an exemplary method (170) for managing and exchanging resources between enterprises in a cloud computing environment in accordance with an embodiment of the present disclosure. At step 180, one or more enterprise data is collected from each of the enterprises in a pre-defined format. In one aspect of the specific embodiment, the one or more enterprise data is collected by an information collection subsystem 20.

At step 190, one or more collected enterprise data is classified into one or more resource groups based on the type and content of the enterprise data using an artificial intelligence-based segmentation model. In one aspect of the specific embodiment, the one or more collected enterprise data is classified by an information classifying subsystem 30.

At step 200, classified one or more resource groups are distributed dynamically with each other based on one or more predefined parameters using an artificial intelligence-based data recommendation technique. In one aspect of the present embodiment, the classified one or more resource groups are distributed dynamically by a dynamic distribution subsystem 40. In another aspect of the present embodiment, each of the one or more resource groups comprises one or more resources corresponding to the one or more collected enterprise data.

In yet another embodiment, distributing dynamically of the classified one or more resource groups with each other comprises generating a score based on the one or more predefined parameters and assigning a rank on the generated score. Here, the one or more resource groups are distributed with each other based on the rank.

At step 210, one or more performance data associated with the enterprise is generated based on the dynamically distributed one or more resource groups. In one aspect of the present embodiment, the one or more performance data associated with the enterprise is generated by the performance data generator subsystem 50. In another aspect of the present embodiment, the one or more predefined parameters comprises at least one of parameter representative of experience level, exclusivity, availability, time zone difference, budget, social impact, languages, contract agreement type, and delivery time.

In yet another aspect of the present embodiment, the performance data associated with the enterprise data is validated using one or more pre stored validation rules. In such aspect of the present embodiment, the performance data is visualized in or more graphical representation form on a user interface of a user device.

At step 220, one or more operations on the one or more resources is performed based on type of the one or more resources and one or more user privileges. In one aspect of the present embodiment, the one or more operations on the one or more resources is performed by a resource operation management subsystem 60. In another aspect of the present embodiment, performance data associated with one enterprise data is analysed with respect to performance data associated with another enterprise data using artificial intelligence-based enterprise data model. In such aspect of the present embodiment, the one or more operations on the one or more resources of the one enterprise data is recommended based on the analysis.

In another aspect of the present embodiment, performing of the one or more actions comprises providing an interactive artificial intelligence assisted chatting interface to the one or more users, providing the legal arbitration component for the one or more users, producing digital accounting documentation for the one or more users, managing digital assets of the enterprise and providing compensation to the users via electronic payment.

The method also includes registering each of the enterprises with two set of details, organizational and individual.

This method and system can be used for any organizational transactions that involve services as part of the exchange. From temporary to permanent occupations, including transactional operations; production development; value transferring or licensing through affiliate programs, franchising, representation contracts, or distribution; whether at importation or exportation processes. It is ideal for optimizing national and global workforce employment gaps throughout the implementation, development, and management of massive or new production processes, information, and control systems, and computer-controlled inspection, assembly and handling. The present disclosed system reduces unnecessary steps for searching prospective targets, and for negotiating, agreeing, trading and delivering services from a business to another business, which ends up contributing for the entire global economy's health and prosperity, since this type of trade circulates four times more than business-to-consumer eCommerce. The system stimulates usability with a library module supporting virtual communication and learning acquisition.

The platform also provides some software integration capability and data management as a delivery model. The optional integrations enable users to connect, execute and configure integration flows, driving the deployment of integrations without installing or managing any hardware. Optional data management offers authentication and management of programs for the users, who access their data to execute an exchange of information and resources through data-visualization tools.

The present system focuses on providing radical co-generation in business-to-business relationships, which manifests into cooperation in the production process. Unlike the prior art systems which deals with collaboration between people working with other people, the present system deals between different companies (one organizational entity working via individual entities with another organizational entity working via individual entities, therefore two layers of social groups). In this way, where the organization is treated as a user, right control to different forms of organizational data is given in the right way to the individuals.

Further, the organizational users can have independent control over data, and at the same time have to agree about how the data is visualized mutually between them and the other party, besides configuring how their relational and transactional information is seen with consensual validation processes involving the other parties that worked with them.

Furthermore, the present platform provides a system that bases on matchmaking of service portfolios and validation of factual reputation of organizational work performance. The present invention verifies then such portfolios through real parties who worked with them and that this system also tracks with performance metrics.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system to manage and exchange resources between enterprises in a cloud computing environment, the system comprising:
a hardware processor; and
a memory coupled to the processor, wherein the memory comprises a set of program instructions in the form of a plurality of subsystems, configured to be executed by the processor, wherein the plurality of subsystems comprises:
an information collection subsystem configured to collect one or more enterprise data from each of the enterprises in a pre-defined format;
an information classifying subsystem configured to classify one or more collected enterprise data into one or more resource groups based on the type and content of the enterprise data using an artificial intelligence-based segmentation model, wherein each of the one or more resource groups comprises one or more resources corresponding to the one or more collected enterprise data;
a dynamic distribution subsystem configured to dynamically distributes the classified one or more resource groups with each other based on one or more predefined parameters using an artificial intelligence-based data recommendation technique, wherein the one or more predefined parameters comprises at least one of parameter representative of experience level, exclusivity, availability, time zone difference, budget, social impact, languages, contract agreement type, and delivery time;
a performance data generator subsystem configured to generate one or more performance data associated with the enterprise based on the dynamically distributed one or more resource groups; and
a resource operation management subsystem configured to perform one or more operations on the one or more resources based on type of the one or more resources and one or more user privileges.

2. The system of the claim 1, further comprises a registration module configured to register each of the enterprises with a first set of details, wherein the first set of details comprises organizational and individual details such as enterprise name, enterprise address and enterprise business domain details.

3. The system of the claim 1, wherein performing of the one or more operations comprises providing an interactive artificial intelligence assisted chatting interface to the one or more users, providing the legal arbitration component for the one or more users, producing digital accounting documentation for the one or more users, managing digital assets of the enterprise and providing compensation to the users via electronic payment.

4. The system of the claim 1, wherein the one or more resources groups comprises projects group associated with the enterprise, account group associated with the enterprise, template group associated with the enterprise and library group.

5. The system of the claim 1, wherein the one or more enterprise data comprises enterprise performance and reputation data, enterprise identity data, enterprise offer or demand data, and enterprise current availability data.

6. The system of the claim 1, wherein the dynamically distributes of the classified one or more resource groups with each other comprises:
generation of a score based on the one or more predefined parameters;
assign a rank on the generated score; and
distributing the one or more resource groups with each other based on the rank.

7. The system of claim 1, further comprises a validation subsystem configured to validate the performance data associated with the enterprise data using one or more pre stored validation rules.

8. The system of claim 1, further comprises a visualization subsystem configured for visualizing the performance data in one or more graphical representation form on a user interface of a user device.

9. The system of claim 1, further comprises enterprise data collaboration subsystem configured for:
analysing performance data associated with one enterprise data with respect to performance data associated with another enterprise data using artificial intelligence-based enterprise data model; and
recommending the one or more operations on the one or more resources of the one enterprise data based on the analysis.

10. A method for managing and exchanging resources between enterprise in a cloud computing environment, the method comprises:
collecting, by a processor, one or more enterprise data from each of the enterprises in a pre-defined format;
classifying, by the processor, one or more collected enterprise data into one or more resource groups based on the type and content of the enterprise data using an artificial intelligence-based segmentation model, wherein each of the one or more resource groups comprises one or more resources corresponding to the one or more collected enterprise data;
distributing, by the processor, dynamically the classified one or more resource groups with each other based on one or more predefined parameters using an artificial intelligence-based data recommendation technique, wherein the one or more predefined parameters comprises at least one of parameter representative of experience level, exclusivity, availability, time zone difference, budget, social impact, languages, contract agreement type, and delivery time;
generating, by the processor, one or more performance data associated with the enterprise based on the dynamically distributed one or more resource groups; and
performing, by the processor, one or more operations on the one or more resources based on type of the one or more resources and one or more user privileges.

11. The method of the claim 10, further comprising registering, by the processor, each of the enterprises with a first set of details, wherein the first set of details comprises organizational and individual details such as enterprise name, enterprise address and enterprise business domain details.

12. The method of the claim 10, wherein performing of the one or more actions comprises providing an interactive artificial intelligence assisted chatting interface to the one or more users, providing the legal arbitration component for the one or more users, producing digital accounting documentation for the one or more users, managing digital assets of the enterprise and providing compensation to the users via electronic payment.

13. The method of the claim 10, wherein distributing dynamically of the classified one or more resource groups with each other comprises:
generating a score based on the one or more predefined parameters;
assigning a rank on the generated score; and
distributing the one or more resource groups with each other based on the rank.

14. The method of the claim 10, further comprising validating, by the processor, the performance data associated with the enterprise data using one or more pre stored validation rules.

15. The method of the claim 10, further comprising visualizing, by the processor, the performance data in one or more graphical representation form on a user interface of a user device.

16. The method of the claim 10, further comprising analysing, by the processor, performance data associated with one enterprise data with respect to performance data associated with another enterprise data using artificial intelligence-based enterprise data model.

17. The method of the claim 16, further comprising recommending, by the processor, the one or more operations on the one or more resources of the one enterprise data based on the analysis.
